(19) United States
(12) Patent Application Publication
(10) Pub. No.: US 2003/0019560 A1
(43) Pub. Date: Jan. 30, 2003

(54) Releasable bonding system for impermeable floor converings

(76) Inventor: Robert Jeffrey Mabbutt, Hawarden (GB)

Correspondence Address: DENNISON, SCHULTZ & DOUGHERTY, 1745 JEFFERSON DAVIS HIGHWAY, ARLINGTON, VA, 22202, US

(21) Appl. No.: 10/203,655

(22) PCT Filed: Feb. 28, 2001
(86) PCT No.: PCT/GB01/00842

(30) Foreign Application Priority Data
Mar. 2, 2000 (GB) 0004920.5

(51) Int. Cl. B32B 35/00

(52) U.S. Cl. 156/71; 52/309.1; 52/746.1; 52/403.1

(57) ABSTRACT

A releasable bonding system especially suited for releasably bonding impermeable floor coverings (6) such as vinyl and linoleum in tile and sheet form to a floor surface (5). On preparing a suitable surface (5), a quantity of a first water-based adhesive (4) is applied, into which a porous intermediate membrane (7) can then be laid and brushed over carefully. Once a convenient area of the porous intermediate membrane (7) has been laid, a second adhesive (2) may be applied, into which the impermeable covering (6) can then be laid and rolled in the usual manner. The second adhesive (2) dries through the porous intermediate membrane (7) to the floor surface (5). At a time of replacement or repair, when the floor covering is removed (6), the porous intermediate membrane (7) is also removed, leaving an undamaged floor surface (5) with an adhesive residue which may either be washed away to remove it or have fresh adhesive applied over it.

This invention relates to a releasable bonding system especially suited for releasably bonding impermeable floor coverings such as vinyl and linoleum in both tile and sheet form to a floor surface.

The conventional method of bonding impermeable floor coverings has been the wet bonding technique. In this process, adhesive is applied to the floor and the floor covering placed into the adhesive whilst it is still wet and receptive. The whole installation is then rolled in order to ensure that adhesive has fully transferred to the back of the floor covering, which enables maximum bond strength to be achieved. Typically, the installation is then left for 24 hours before subjecting it to heavy trafficking, which ensures that the bond is not damaged in its development stages. However, the problem associated with this approach is that on uplifting the floor covering, adhesive residue is often found to remain on the floor surface and, on many occasions, damage to the floor may occur.

There are many occasions when it is desirable to release previously bonded floor coverings, for example, when the installation is due for replacement or repair. For replacement to be considered, any adhesive residue must be carefully removed and/or a smoothing compound applied in order to provide a new level, absorbent surface. Not only is inconvenience caused by either partial or total closure of an area while the worn or damaged coverings are removed and made good, but the cost of doing so may be prohibitive.

Floor covering release systems for carpets and other porous materials are well known. Using this technique, a water-based adhesive is first applied to the prepared floor surface and an intermediate membrane, such as siliconised paper, laid into the adhesive and brushed flat. A second adhesive is then applied to the intermediate membrane and the carpet laid into the wet adhesive before being thoroughly rolled to ensure good contact. When this installation is removed, all that will remain on the floor is a residue of the first adhesive, which being water-soluble, can simply be washed down or brushed off as appropriate prior to the next installation.

Unfortunately, this technique is not appropriate for certain impermeable coverings where the adhesive applied between the intermediate membrane and the floor covering does not dry sufficiently quickly, which leads to blistering problems and increased downtime.

Other prior art arrangements include WO 91/19445 (Schuster) and NL1000700 (Vof Pegon) which disclose double-sided tape-based membranes for bonding a variety of floor coverings. However, these bonding systems would again be unsuitable for securing impermeable floor coverings, such as linoleum or vinyl, since the dry tape-based adhesive would not be able to penetrate into the backing. As such, the strength of the bond would be inadequate, which would inevitably cause problems where there is heavy wear and traffic. Furthermore, on uplifting the floor covering, the dry tape-based adhesive may damage the floor surface necessitating the application of a cementitious smoothing compound, or leave adhesive residue which needs further treatment.

It is the object of this invention to provide an improved release system and method for bonded impermeable floor coverings, such as vinyl and linoleum.

The present invention provides a method for releasably securing an impermeable floor covering to a surface, comprising the steps of:

(a) applying at least one suitable first adhesive layer to said surface;

(b) releasably securing an intermediate membrane to said surface by means of said first adhesive layer;

(c) applying at least one suitable second adhesive layer to said intermediate membrane; and

(d) securing said impermeable covering to said intermediate membrane by means of said second adhesive layer;

characterised in that:

said intermediate membrane is sufficiently porous or perforated to enable said second adhesive layer to dry therethrough.

In accordance with a further aspect of the present invention, there is provided a releasable bonding system for securing an impermeable floor covering to a surface, comprising:

(a) at least one suitable first adhesive layer applied to floor surface;

(b) an intermediate membrane releasably secured to said surface by means of said first adhesive layer;

(c) at least one suitable second adhesive layer applied to said intermediate membrane for securing said impermeable covering to said intermediate membrane;

characterised in that:

said intermediate membrane is sufficiently porous or perforated to enable said second adhesive layer to dry therethrough.

The advantages of the present invention are that the second adhesive layer can dry through the porous membrane to the floor surface. As before, a water-based adhesive is first applied to the floor surface and an intermediate membrane, laid into the adhesive and brushed flat. A second adhesive is then applied to the intermediate membrane and the impermeable floor covering laid into the wet adhesive before being thoroughly rolled to ensure good contact. However, in this present invention, the intermediate membrane is sufficiently porous to enable the second adhesive layer to dry through the membrane to the floor. Likewise, at the time of replacement or repair, when the floor covering is removed, the intermediate membrane is also removed, leaving an undamaged floor surface with an adhesive residue which may either be washed away to remove it or have fresh adhesive applied over it, prior to the application of a new covering. The benefits arise through ease of installation and significantly reduced downtime, thereby saving the end user both time and money. Therefore, the present invention is particularly suited for installation in many commercial and private premises, such as, retail outlets, hotels, airports, passenger trains and cruise ships.

A specific embodiment of the invention will now be described by way of example and with reference to the accompanying drawings, in which:

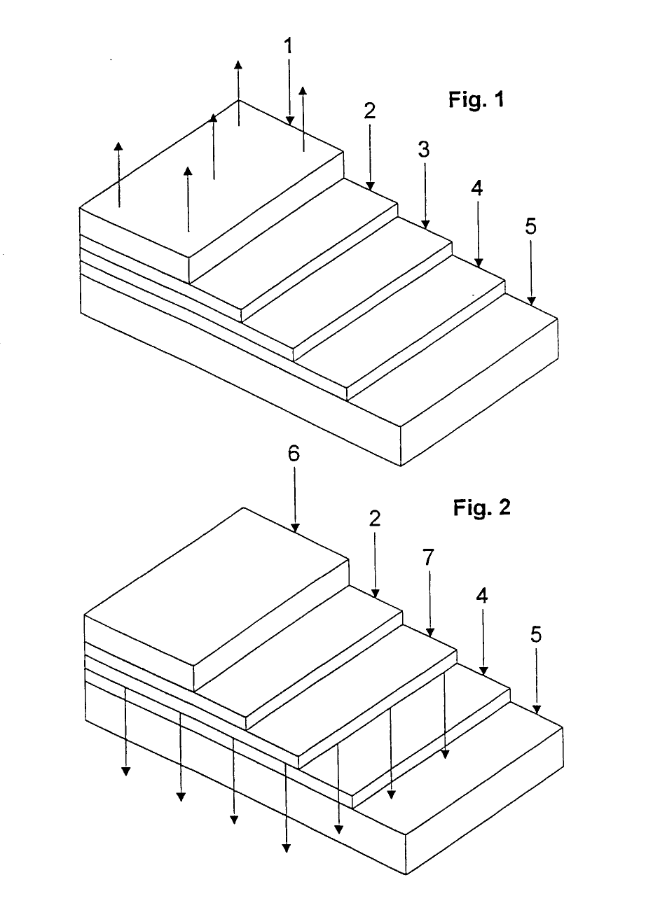

FIG. 1 illustrates a perspective view of a conventional floor covering release system especially suited for carpet and other porous coverings;

FIG. 2 is a perspective view of the present invention.

Referring to the drawings, FIG. 1 illustrates the method of releasably securing a porous covering (1), such as a carpet, to a suitable surface (5), such as a floor. In this technique, a water-based adhesive (4) is applied to the prepared floor (5) and an intermediate membrane (3) laid into the adhesive and brushed flat. A second adhesive (2) is then applied to the intermediate membrane (3) and the covering (1) laid into the wet adhesive before being rolled. The second adhesive (2) is then allowed to dry through the porous covering (1).

The present invention depicted in FIG. 2, illustrates the method of releasably securing an impermeable covering (6), such as vinyl and linoleum, to a surface (5). Careful attention to the preparation of the floor (5), prior to laying a bonded floor covering (6) is essential if the installation is to remain trouble free. The surface condition, type and construction will all have a bearing on the adhesive selection, and application procedures.

In order to secure an impermeable covering, the porous intermediate membrane (7) is usually supplied as a roll. After preparing the floor, a quantity of the first adhesive (4) is applied to the floor surface (5) using, for example, a notched trowel at a coverage of around 0.35 litres per m². The porous intermediate membrane (7) can then be rolled out over the first adhesive (4) and brushed over carefully, ensuring that no air bubbles are entrapped. Once a convenient area of the porous intermediate membrane (7) has been laid, the second adhesive (2) may be applied. The impermeable covering (6) can then be laid and rolled in the usual manner. The second adhesive (2) dries through the porous intermediate membrane (7) to the floor surface (5). Preferably, the porous intermediate membrane (7) will be formed from a plastics material having a predetermined density of small perforations.

The invention described can also be utilised using the latest pressure sensitive adhesives which have been developed to take advantage of -the dry tack properties of modern products. In this process, an adhesive is applied to the intermediate membrane (7) with a notched trowel, which is then rolled with a roller pre-wetted with adhesive. This flattens out the adhesive ridge marks and maximises the contact area between the second adhesive (2) and the floor covering (6). The second adhesive (2) is then allowed to dry fully prior to placing the covering (6). Once the floor covering (6) has been placed and the installation completed, it is thoroughly rolled to ensure good contact and the installation can be open to immediate trafficking.

When the floor covering (6) requires uplifting, the covering (6) and intermediate membrane (7) are simply loosened at one corner and carefully pulled back together. All that will remain on the floor surface (5) is a residue of the first adhesive (4), which being water-soluble, can simply be washed down or brushed off as appropriate prior to the next installation.

1. A method for releasably securing an impermeable floor covering (6) to a surface (5), comprising the steps of:
(a) applying at least one suitable first adhesive layer (4) to said surface (5);
(b) releasably securing an intermediate membrane (7) to said surface by means of said first adhesive layer (4);
(c) applying at least one suitable second adhesive layer (2) to said intermediate membrane (7); and
(d) securing said impermeable covering (6) to said intermediate membrane by means of said second adhesive layer (2);
characterised in that:
said intermediate membrane (7) is sufficiently porous or perforated to enable said second adhesive layer to dry therethrough.

2. A method for releasably securing an impermeable floor covering (6) to a surface (5) according to claim 1, further comprising a step in which said intermediate membrane (7), releasably secured to said surface (5) by means of said first adhesive layer (4), is brushed flat prior to the application of said second adhesive (2).

3. A method for releasably securing an impermeable floor covering (6) to a surface (5) according to claim 1, further comprising a step in which said impermeable floor covering (6), secured to said intermediate membrane (7) by means of said second adhesive layer (2), is thoroughly rolled to ensure good contact prior to trafficking.

4. A releasable bonding system for securing an impermeable floor covering (6) to a surface (5), comprising:
(a) at least one suitable first adhesive layer (4) applied to floor surface (5);
(b) an intermediate membrane (7) releasably secured to said surface (5) by means of said first adhesive layer (4);
(c) at least one suitable second adhesive (2) layer applied to said intermediate membrane (7) for securing said impermeable floor covering (6) to said intermediate membrane (7);
characterised in that:
said intermediate membrane (7) is sufficiently porous or perforated to enable said second adhesive layer to dry therethrough.

5. A releasable bonding system for securing an impermeable floor covering (6) to a surface (5) according to claim 4, characterised in that said first adhesive layer (4) is water-soluble.

6. A releasable bonding system for securing an impermeable- floor covering (6) to a surface (5) according to claim 4, characterised in that said intermediate membrane (7) comprises of a perforated plastics material.

7. A releasable bonding system for securing an impermeable floor covering (6) to a surface (5) according to claim 4, characterised in that said impermeable floor covering (6) comprises of linoleum or vinyl in tile or sheet form.

8. A method for releasably securing an impermeable floor covering (6) to a surface (5) substantially as described herein with reference to FIG. 2 of the accompanying drawings.

9. A releasable bonding system for securing an impermeable floor covering (6) to a surface (5) substantially as described herein with reference to FIG. 2 of the accompanying drawings.
